(19) United States
(12) Patent Application Publication
(10) Pub. No.: US 2025/0004618 A1
(43) Pub. Date: Jan. 2, 2025

(54) METHOD OF SWITCHING DISPLAY CONTENT, DEVICE AND STORAGE MEDIUM

(71) Applicant: Beijing Zitiao Network Technology Co., Ltd., Beijing (CN)

(72) Inventors: Renming XIANG, Beijing (CN); Ronghui ZHANG, Beijing (CN); Shujing ZHANG, Beijing (CN); Jiexin YUAN, Beijing (CN); Jinhong WANG, Beijing (CN); Xuezhi HU, Beijing (CN); Wenjing YU, Beijing (CN)

(21) Appl. No.: 18/758,627

(22) Filed: Jun. 28, 2024

(30) Foreign Application Priority Data
Jun. 30, 2023 (CN) 202310797704.5

(51) Int. Cl. G06F 3/0484

(52) U.S. Cl. CPC G06F 3/0484

(57) ABSTRACT

A method of switching content, apparatus, device and storage medium are provided. When the user wants to switch the display interface from the first functional interface to the second functional interface, the first switching operation may be triggered. After the first switching operation is acquired, the first display content may be determined according to the content historically displayed by the second functional interface, and the first display content is displayed at the display interface.

### CROSS-REFERENCE TO RELATED APPLICATION

This application claims the priority to and benefits of the Chinese Patent Application, No. 202310797704.5, which was filed on Jun. 30, 2023. The aforementioned patent application is hereby incorporated by reference in its entirety.

### TECHNICAL FIELD

The present disclosure relates to the field of computers, and in particular, to a method of switching display content, an apparatus, a device and a storage medium.

### BACKGROUND

As technology evolves, functional integration is an important trend in software development. Therein, functional integration refers to integrating multiple functions into the same software. For example, in addition to instant messaging function, the instant messaging software may also integrate with a plurality of functions such as video conferencing function, scheduling function, and mail. Integrating different functions into the same software can improve the user experience.

Alternatively, the application for editing the edited object may integrate various editing functions. Specifically, the application program may include a plurality of function modules, each function module is configured to implement a different editing function. When editing a certain edited object, it may be necessary to switch between different functional modules.

### SUMMARY

In order to solve the problems of the prior art, the present disclosure provides a method of switching display content, an apparatus, a device and a storage medium.

Based on this, the technical solutions provided by the present disclosure are as follows:

In a first aspect, the present disclosure provides a method of switching display content, and the method comprising:

Acquiring a first switching operation, the first switching operation is configured to switch a display interface from a first functional interface to a second functional interface, the first functional interface is configured to implement a first editing function, and the second function interface is configured to implement a second editing function;

Determining a first display content, the first display content is determined according to a historical display content of the second functional interface; and

Displaying the first display content at the display interface.

In some possible implementations, wherein the first functional interface is configured to edit a first aspect of a target application, and the second functional interface is configured to edit a second aspect of the target application.

In some possible implementations, wherein the first switching operation is triggered by a first switching control, and the first switching control is a control displayed on the first functional interface.

In some possible implementations, wherein the interface indicated an interface indicated by the first display content is determined according to the second functional interface displayed on the display interface at a first moment, the first moment is a moment at which the display interface is switched from the second functional interface to an interface different from the second functional interface, and the first moment is earlier than a moment at which the first switching operation is acquired.

In some possible implementations, a functional interface comprises a management interface and a sub-interface, the management interface is configured to manage an editable flowchart page, and the sub-interfaces is configured to edit the flowchart page;

If the display interface at the first moment being the management interface, the display interface is a content displayed by the management interface;

If the display interface at the first moment being the sub-interface, the display interface is a content displayed by the sub-interface.

In some possible implementations, after acquiring the first switching operation, the method further comprises:

Storing a second display content, the second display content is determined according to a content displayed by the first functional interface when the first switching operation is acquired.

In some possible implementations, the method further comprises:
Acquiring a second switching operation, the second switching operation is configured to switch the display interface to the first functional interface;
Determining a third display content according to the second display content;
Displaying the third display content.

In some possible implementations, the determining a third display content according to the second display content comprises:
Determining data adjustment information according to an operation acquired within a target time period, wherein the target time period is a time period from acquiring the first switching operation to acquiring the second switching operation;
Adjusting the second display content according to the data adjustment information to obtain the third display content.

In a second aspect, the present application provides an apparatus for switching display content, the apparatus comprising: an acquiring unit, used for acquiring a first switching operation, wherein the first switching operation is configured to switch a display interface from a first functional interface to a second functional interface, the first functional interface is configured to implement a first editing function, and the second function interface is configured to implement a second editing function. A determining unit, used for determining a first display content, wherein the first target display content is determined according to a historically displayed content of the second functional interface. A display unit, used for displaying the first display content on the display interface.

In some possible implementations, the first functional interface is configured to edit a first aspect of a target application, and the second functional interface is configured to edit a second aspect of the target application.

In some possible implementations, the first switching operation is triggered by a first switching control, and the first switching control is a control displayed on the first functional interface.

In some possible implementations, an interface indicated by the first display content is determined according to the second functional interface displayed on the display interface at a first moment, the first moment is a moment at which the display interface is switched from the second functional interface to an interface different from the second functional interface, and the first moment is earlier than a moment at which the first switching operation is acquired.

In some possible implementations, the plurality of interfaces comprises a management interface and a sub-interface, the management interface is configured to manage an editable flowchart page, and the sub-interfaces is configured to edit the flowchart page; if the display interface at the first moment is the management interface, the target interface is a content displayed by the management interface; if the display interface at the first moment is the sub-interface, the target interface is a content displayed by the sub-interface.

In some possible implementations, the apparatus further comprises a storage unit, a storage unit is configured to store a second display content, wherein the second display content is determined according to a content displayed by the first functional interface when the first switching operation is acquired.

In some possible implementations, the acquiring unit, further configured to acquire a second switching operation, the second switching operation is configured to switch the display interface to the first functional interface. The determining unit, further configured to determine a third display content according to the second display content. The display unit further configured to display the third display content.

In some possible implementations, the determining unit is specifically configured to data adjustment information according to an operation acquired within a target time period, the target time period is a time period from acquiring the first switching operation to acquiring the second switching operation. Adjust the second display content according to the data adjustment information to obtain the third display content.

In a third aspect, the present disclosure provides an electronic device, comprising:
One or more processors;
A storage apparatus, on which one or more programs are stored,
when the one or more programs are executed by the one or more processors, the one or more processors are caused to implement the method according to any one of the first aspect.

In a fourth aspect, the present disclosure provides a computer readable medium, on which a computer program is stored, when the program is executed by a processor, the method described in any one of the first aspects is implemented.

In a fifth aspect, the present disclosure provides a computer program product, which, when run on a device, causes the device to execute the method described in the first aspect.

### BRIEF DESCRIPTION OF DRAWINGS

In order to more clearly illustrate the technical solutions in the embodiments of the present disclosure or the prior art, the following will simply introduce the drawings to be used in the description of the embodiments or the prior art, and it is obvious that the drawings in the following description are only some of the embodiments described in the present disclosure, and other drawings can be obtained according to these drawings for those of ordinary skill in the art without paying inventive step.

FIG. 1 is a flowchart of a method of switching display content provided by an embodiment of the present disclosure;

FIG. 2A is a schematic diagram of an exemplary application scenario provided by an embodiment of the present disclosure;

FIG. 2B is a schematic diagram of another exemplary application scenario provided by an embodiment of the present disclosure;

FIG. 3 is a schematic structural diagram of a display content switching apparatus provided by an embodiment of the present disclosure; and

FIG. 4 is a schematic diagram of a basic structure of an electronic device provided by an embodiment of the present disclosure.

### DETAILED DESCRIPTION

Embodiments of the present disclosure will be described in more detail below with reference to the accompanying drawings. While certain embodiments of the present disclosure are illustrated in the accompanying drawings, it is to be understood that the present disclosure may be embodied in various forms and should not be construed as limited to the embodiments set forth herein, but rather, these embodiments are provided for a more thorough and complete understanding of the present disclosure. It should be understood that the drawings and examples are for illustrative purposes only and are not intended to limit the scope of the present disclosure.

It should be understood that the various steps recited in the method implementation of the present disclosure may be performed in a different order, and/or in parallel. Further, the method implementation may include additional steps and/or omit performing illustrated steps. The scope of the present disclosure is not limited in this regard.

As used herein, the term “include” and variations thereof are open inclusion, that is, “including, but not limited to”. The term “based on” is “based at least in part on.” The term “one embodiment” means “at least one embodiment”; The term “another embodiment” means “at least one additional embodiment”; The term “some embodiments” means “at least some embodiments”. Relevant definitions for other terms will be given in the description below.

Note that the concepts such as “first”, “second” and the like mentioned in the present disclosure are only used to distinguish different objects, devices, modules or units, and are not used to limit the sequence or interdependence of the functions performed by these apparatuses, modules or units.

It is noted that the modifications referred to as “a” or “a plurality” in this disclosure are illustrative rather than limiting, and those skilled in the art should understand that it should be understood as “one or more” unless the context clearly indicates otherwise.

For software with multiple editing functions, a user may need to switch between different functional modules during editing of an edited object. Accordingly, different functional modules may correspond to different functional interfaces. However, the current switching method has a poor user experience.

Exemplification. In an application editing scenario, a user is able to develop an application service within an application Platform as a Service (aPaaS) platform. The aPaaS platform features low or zero code, and users are able to create applications in the aPaaS platform by “dragging, pulling, and dropping” elements and modules provided by the platform, enabling low-threshold rapid creation of applications. A user, during the generation of an application using the aPaaS platform, can first set up a flow chart associated with the produced application in order to perform subsequent production of the application with reference to the flow chart.

The aPaaS platform is capable of providing related functionality to draw flowcharts. In the process of rendering the flow chart, a variety of information may be managed. To this end, the aPaaS platform may include multiple functional interfaces, different functional interfaces for implementing different functions. During the process of drawing or editing the flow chart, it may be necessary to switch between different functional interfaces.

The rendering and management of flowcharts is one of the important functions of the aPaaS platform. Through the aPaaS platform, the user may draw the flow chart and create applications corresponding to the flow charts through the aPaaS platform. Specifically, users can edit processes related to production applications in the aPaaS platform. For example, the user can edit the application's data processing process for subsequent reference during the production of applications in the aPaaS platform. the aPaaS platform. The flow is generally presented in the form of a flow chart. The user is able to edit the required flow chart on the process editing page provided by the aPaaS platform.

In a practical scenario, an aPaaS platform may have multiple functional interfaces, and different functional interfaces may be configured to implement different functions. For example, the aPaaS platform may include functional interfaces for managing different flowcharts, a functional interface for editing flowcharts, and a functional interface for managing variable values in flowcharts.

Accordingly, in the process of using an aPaaS platform, there may be a need to switch between multiple functional interfaces. For example, assuming that a user creates a corresponding application through a flow chart using the aPaaS platform, the user can draw the flow chart on a functional interface for editing the flow chart. In this functional interface, the user can select a value for an object in the flow chart. Accordingly, if the selectable items of an object do not meet the user's requirements, the user may switch to the functional interface for managing the values of the variables in the flow chart, thereby adding the selectable items of the object in the flow chart to the functional interface.

As another example, in some low-code scenarios, a user may not only draw a flow chart in an aPaaS platform, but also design code or pseudo-code corresponding to a node in the flow chart in the aPaaS platform. Accordingly, after the flowchart drawing is complete, the user may switch from the functional interface for editing the flowchart to the functional interface for editing the code.

As can be seen from the above introduction, for application scenarios such as aPaaS platforms, where multiple functional interfaces may exist, there may be a need to switch between the multiple functional interfaces.

One functional interface may include a parent interface and a sub-interface. Wherein one or more controls may be included on the parent interface, the user may control the display of the sub-interface by triggering the controls on the parent interface. When the user switches to a functional interface, the parent of the functional interface will be displayed first. However, the parent interface often does not have specific functionality, requiring the user to trigger a corresponding action in the parent interface to enter the sub-interface to provide the specific functionality. Also, functional interfaces that switch to other functions may also need to be returned to the parent interface, and no switch can be made in the sub-interface. In some possible implementations, a parent interface may be configured to implement management functionality. Correspondingly, the parent interface of a certain functional interface may also be referred to as the management interface of that functional interface.

Thus, if the user needs to switch to other functional interfaces while processing the flow chart in a sub-interface, the user first needs to return to the parent interface corresponding to the sub-interface and switch to other functional interfaces through the controls of the parent interface. After entering other functional interfaces, what the user first sees is the parent of that functional interface. If the user wants to use a certain function of the functional interface, it is also necessary to enter a specific sub-interface of the functional interface.

For example, assuming that a user needs to adjust the value range of options in a flow chart during the process of editing the flow chart, the user first needs to return from a sub-interface of the functional interface that edits the flow chart to a parent interface of the functional interface that edits the flow chart. And then switching from the parent of the function interface that edits the flow chart to the parent of the function interface that adjusts the value range. And re-triggering a control on a parent interface of the adjust-value-range functional interface to enter a sub-interface of the adjust-value-range functional interface. In this sub-interface, the user can adjust the range of values of the options in the flow chart. Then, the user may then return to the parent interface of the functional interface for adjusting the value range, then switch to the parent interface of the functional interface for editing flow chart, and finally enter the sub-interface of the functional interface for editing the flow chart in order to edit the flow chart again. In the above process, the user switches between interfaces a total of 6 times. In an actual application scenario, each interface switching has a large impact on the user experience.

As can be seen from the above description, it is inconvenient for a user to switch between different function interfaces due to the relative independence between the respective functional interfaces. For example, in the above example, the user's adjustment of the value range of options requires a large number of operations for the users. These complex operations may significantly impact the user experience.

In order to solve the above problems, embodiments of the present disclosure provide a method of switching display content, which will be described in detail below in conjunction with the specification drawings.

Embodiments of the present disclosure provide a method of switching display content, apparatus, device and storage medium. If the user wants to switch the display interface from the first functional interface to the second functional interface, the first switching operation may be triggered. After the first switching operation is acquired, the first display content may be determined according to the historical display content of the second functional interface, and displayed at the display interface. Therefore, after switching to the second functional interface, the content seen by the user may not be the original content of the second functional interface, but may be the first display content determined according to the historical display content of the second functional interface. That is, when switching from one functional interface to another functional interface, the content displayed on the switched functional interface is not the original content of the functional interface but the display content determined according to the historical display situation of the functional interface. As such, the user does not need to re-operate on the second functional interface, the operation path of the user is reduced, and the user experience is improved.

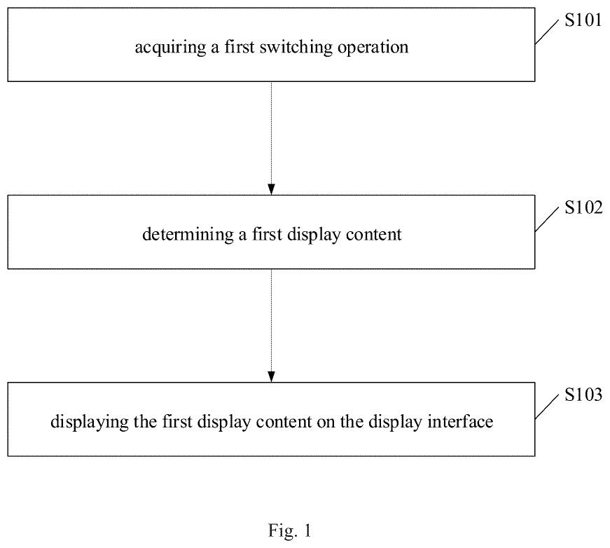

Referring to FIG. 1, FIG. 1 is a flow diagram schematic of a method of switching display content provided by an embodiment of the present disclosure, the embodiment of the present disclosure may be applicable to an application scenario of editing the flow diagram. The method of switching display content may be performed by a display content switching apparatus, which may be implemented by software, integrated in a client of a user. The client may be a software client of aPaaS or a web client. If the client is a software client of aPaaS, the client may be integrated in a Personal Computer (PC) side or in a mobile terminal. In some possible implementations, the client may be a module in other software having a flow chart editing function, such as an aPaaS module. The other software mentioned above may be a software having an instant communication function, and may be office software, for example. Namely, the above-mentioned client may be an aPaaS module in the instant messenger software.

As shown in FIG. 1, the method specifically comprises the following steps:

S101: Acquiring a first switching operation.

During the user's use of the software with flow chart editing, the user may trigger the switching operation if the user wants to switch from one functional interface to another. In the embodiment of the present disclosure, if the user wants to switch the display interface from the first functional interface to the second functional interface, the user may trigger the first switching operation.

Therein, the display interface refers to the currently displayed interface, i.e., the screen area seen by the user. Alternatively, if the user edits the flowchart through an aPaaS platform running on the terminal device, the display interface may be a corresponding display area of a client of the aPaaS platform on a display module of the terminal device. That is, if the user wants to switch the aPaaS displayed interface, the user may trigger the first switch operation.

In an embodiment of the present disclosure, the first switching operation is configured to switch the display interface from the first functional interface to the second functional interface. Wherein the first functional interface and the second functional interface are functional interfaces, and the first functional interface and the second functional interface are configured to implement different functions. For example, the first function interface may be configured to implement a first editing function, and the second function interface is configured to implement a second editing function.

Optionally, the first editing function and the second editing function may be editing functions for different aspects of the same edited object. For example, in an application scenario corresponding to the aPaaS platform, a client corresponding to a display interface is configured to generate an application on a low-code or no-code basis. Accordingly, the first functional interface and the second functional interface may be two interfaces with different editing functions for the same application. For example, a first editing interface may be configured to enable editing of a visualization page of a target application program, and a second editing interface may be configured to enable editing of a data model of the target application program.

Optionally, the client may include a plurality of editing interfaces, which may include the interface for editing the visualization page and the interface for editing the data model described above, as well as related interfaces for editing the process flow of the target application, for editing the code of the target application, for editing the permissions of the target application, and for viewing the edit log, and other related interfaces. In an embodiment of the present disclosure, the first editing interface may be an interface having any of the above functions, and the second editing interface may be an interface having any of the above functions and being different from the first editing interface.

The first functional interface and the second functional interface are described above, and the method of triggering the first switching operation by the user is introduced below.

In an embodiment of the present disclosure, the first switching operation is actively triggered by the user after the user has a need to switch the functional interface displayed by the display interface.

In some possible implementations, the user may trigger the switching operation by way of issuing a voice instruction. Namely, if the terminal device running the client detects that the user utters the preset voice, the client may determine that the user triggers the first switching operation. Optionally, the above-mentioned preset voice may include a voice segment for indicating the second functional interface, to indicate that the first switching operation is configured to switch the display interface to the second functional interface.

In some possible implementations, the user can also trigger the switching operation by way of inputting an instruction. Namely, upon needing to switch the display interface to the second operation interface, the user can set the preset instruction. The client, after acquiring the preset instruction, may parse the preset instruction to determine that the first switching operation is triggered by the user. Similarly, the above-mentioned preset instruction may include relevant information for indicating the second function interface to instruct the first switching operation to switch the display interface to the second functional interface.

In some other possible implementations, the user can also trigger the switching operation through a control. This is described in detail below.

Optionally, one or more switching controls may be included on the display interface. The switching control may be configured to trigger a corresponding display operation. Where the user wants to switch the display interface to the second functional interface, the user may trigger a preset operation on the switching control. After the preset operation triggered by the user is acquired, it may be determined that the first switching operation is triggered by the user. The preset operation may include but is not limited to a single click operation and a double click operation.

To realize switching of functional interfaces, the different functional interfaces may each include a switching control. For example, the above-mentioned first functional interface may include a first switching control, and the above-mentioned second function interface may include a second switching control.

In some possible implementations, the position of switching control may be different in different functional interfaces. For example, in the first functional interface, the switching control may be located in the upper left corner of the first functional interface. In the second functional interface, the switching control may be located at an upper right corner of the second functional interface.

In some other possible implementations, the position of switching control may be different in different functional interfaces. Specifically, a specific display area may be divided in the display interface for displaying the switching control. Accordingly, in each of the functional interfaces that can be displayed by the display area, the display control is located at a position corresponding to the above-mentioned display area.

For example, if the display interface is client software corresponding to an aPaaS platform, the side bar of that client may be used as the display area for displaying the switching control. Therein, the sidebar refers to an edge region of the display interface corresponding to the software, and may include, for example, any one or more of a left sidebar, a right sidebar, an upper sidebar, and a lower sidebar of the software. Correspondingly, when the content displayed by the display interface is switched, the content displayed by the sidebar may remain unchanged or only minor adjustments may be made. As such, when browsing different function interfaces, the user can trigger the switching operation at the same location, improving the user's experience.

Alternatively, if there are other functional interfaces besides the first function interface and the second function interface, a plurality of switching controls may be included on the display interface. Each switching control may correspond to a functional interface. Correspondingly, upon triggering the first switching operation, the user may trigger a preset operation for the switching control corresponding to the second function interface. In this way, the client may determine that the user needs to switch the display interface to the second function interface. Optionally, to distinguish between switching controls to which different functional interfaces correspond, the icons of different switching controls may be different. For example, the switching control corresponding to the first functional interface may include an icon for indicating the first functional interface. The switching control corresponding to the second functional interface may include an icon for indicating the second functional interface.

Alternatively, only one switching control may be included on the display interface if there are other functional interfaces besides the first function interface and the second function interface, only one switching control may also be included on the display interface. The user triggers the function interface displayed by the display interface once each time the switching control is switched. And, the switched functional interfaces may have a preset sequence between them. That is, the client may switch the functional interface displayed by the display interface to the next function interface in a preset sequence every time the user triggers the switching control. That is, if the second functional interface is the next functional interface of the first functional interface in the preset sequence. The user may switch displaying the second functional interface by triggering the switching control one-time. If the functional interface currently displayed by the display interface is the ith functional interface in the preset sequence, the user wants to switch to the ith+nth functional interface, the user can trigger the operation control n times. i and n are both positive integers.

As can be appreciated from the foregoing interfaces, a functional interface may include a management interface and at least one sub-interface. In the embodiment of the present disclosure, the switching operation may be triggered on the management interface, and may also be triggered on the management interface or a sub-interface. Correspondingly, if the first switching operation is triggered by a preset control, the preset control may be displayed only on the management interface, or may be displayed on both the management interface and the sub-interface. As such, the user can switch to the second functional interface both in the management interface of the first functional interface and in the sub-interface of the first functional interface. Thus, the management interface without returning to the functional interface can be switched to another functional interface, simplifying the user operation and improving the user experience.

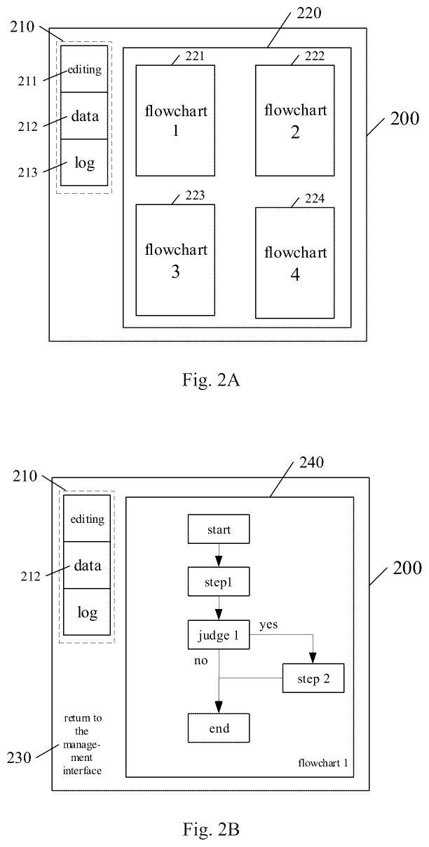

The following describes the implementation shown in FIG. 2A and FIG. 2B as an example. FIG. 2A and FIG. 2B are schematic diagrams illustrating an application scenario provided by the present disclosure. For instance, in a process in which a user edits a flowchart using an aPaaS platform based on a terminal device (e.g., a device such as a computer or a cell phone), the terminal device may display an interface as shown in FIG. 2A or FIG. 2B. The interface may be the interface displayed by the client of the aPaaS platform, corresponding to the display interface mentioned above. FIG. 2A shows the management interface of the functional interface of the editing flow chart, and FIG. 2B shows the sub-interface of the functional interface of the editing flow chart.

In the implementation shown in FIG. 2A, the display interface 200 displays a management interface for editing the functional interface of the flow chart. In FIG. 2A, the display interface 200 includes a switching control display area 210 and a management control display area 220. The switching control display area 210 includes a switching control 211, a switching control 212, and a switching control 213. The management control display area 220 includes a management control 221, a management control 222, a management control 223, and a management control 224.

Specifically, the switching control 211 is configured to switch the interface displayed by the display interface 220 to a functional interface for editing the flow chart; the switching control 212 is configured to switch the interface displayed by the display interface 220 to a functional interface for adjusting the value range of the data; switching control 213 is configured to switch the interface displayed by display interface 220 to a functional interface for managing logs of the aPaaS platform.

The management control 221 is configured to switch the interface displayed by the display interface 220 to the corresponding sub-interface of flowchart 1; management control 222 is configured to switch the interface displayed by display interface 220 to the corresponding sub-interface of flowchart 2; management control 223 is configured to switch the interface displayed by display interface 220 to the corresponding sub-interface of flowchart 3; management control 224 is configured to switch the interface displayed by display interface 220 to the corresponding sub-interface of flowchart 4. Among them, flowchart 1, flowchart 2, flowchart 3, and flowchart 4 may be four flowcharts managed by an aPaaS platform.

In the implementation shown in FIG. 2A, switching control 211, switching control 212, and switching control 213 each include prompt information thereon for prompting the user for the functionality of each switching control. Also, in the implementation shown in FIG. 2A, since the interface displayed by the display interface 200 is a functional interface for editing a flow chart, the display mode of switching control 211 is different from the switching control 212 and the switching control 213. As such, the user may be prompted that switching control 211 in a selected state and display interface 200 is displaying a functional interface for editing the flow chart.

If the user wants to switch from the functional interface for editing the flow chart to another interface, the user may trigger the control displayed in the switching control display area 210. For example, if the user wants to adjust the value range of the data, the user may trigger the switching control 212. After the user triggers the switching control 212, the client of the aPaaS platform may acquire a corresponding switching operation, thereby switching the content displayed by the display interface 200 to the interface indicated by the functional control for adjusting the value range of the data.

Similarly, the management control 221, the management control 222, the management control 223, and the management control 224 also respectively include prompt information thereon for prompting the user for the function of each management control. If the user wants to edit flowchart 1, the user can trigger an action on the management control 221. Correspondingly, the display interface 200 may be as shown in FIG. 2B after obtaining an operation for triggering for the management control 221.

In the implementation shown in FIG. 2B, the display interface 200 displays a sub-interface of a functional interface for editing a flow chart, specifically displays a sub-interface for editing flow chart 1. In the implementation shown in FIG. 2B, a switching control display area 210, a return control 230, and a flowchart display area 240 are included.

Therein, the return control 230 is configured to return to the management interface for editing the functional interface of the flow chart. If the user wants to edit other flowcharts than flowchart 1 (e.g., flowchart 2 in FIG. 2A, etc.), the user may trigger the return control 230. After acquiring the operation triggered by the user through the return control 230, a management interface as shown in FIG. 2A may be displayed for the user to switch to other flow charts for editing.

The flowchart display area 240 is configured to display specific contents of the flowchart 1. In flowchart display area 240, the user may edit flowchart 1. The specific editing operations will not be described in detail here.

In the implementation shown in FIG. 2B, the sub-interface of the functional interface for editing the flow chart also includes a switching control display area 210 for the user to switch the functional interface displayed by the display interface 200. That is, if during editing of the flowchart 1, the user needs to adjust the value range of the variable in the flowchart, the user may trigger a switching operation via the switching control 212 to switch the content displayed by the display interface to a functional interface for adjusting the value range of the data. As such, the user can trigger the switching operation in the sub-interface of the functional interface without returning to the management interface of the functional interface to trigger the switching operation again, simplifying the user operation and improving the user experience.

S102: determining a first display content.

After the first switching operation is acquired, the first display content may be determined. Wherein the first display content is the related content required to be displayed by the display interface after switching to the second functional interface. In the embodiment of the present disclosure, the first display content is determined according to historical display content of the second functional interface. Thus, after the user switches to the second functional interface, the content seen by the user is not the original content of the second functional interface, but the display content determined according to the historical display content of the second functional interface. In this way, there is no need for the user to manipulate the second functional interface, reducing user operations and improving user experience.

Alternatively, the first display content may be determined according to the content displayed by the second functional interface when the display interface last displayed the second functional interface. That is, when switching from the second functional interface to the other functional interface, the content displayed by the second functional interface may be recorded. Correspondingly, after switching back to the second functional interface, the first display content may be determined according to the recorded content.

That is, if switching the display interface from the second functional interface to the other functional interface is referred to as leaving the second functional interface, and switching the display interface from the other functional interface to the second functional interface is referred to as entering the second functional interface, the first display content may be determined according to the content displayed by the second functional interface the last time the user left the second functional interface.

In some possible implementations, the first display content may be configured to indicate a level to which the second functional interface corresponds. The level corresponding to the second functional interface refers to the level between the management interface and the sub-interface. After the first switching operation is acquired, it may be determined whether to display a management interface or a sub-interface of the second functional interface. In particular, if the second functional interface includes multiple levels of sub-interfaces, i.e. a certain sub-interface (or sub-interfaces) of the second functional interface also includes a sub-interface, then the first display content may determine which sub-interface the interface needs to be displayed is.

For example, assuming that before the first switching operation is acquired, the content displayed by the second display interface last time is the management interface of the second functional interface, the first display content may be determined with the management interface of the second functional interface. As such, when switching back to the second functional interface, the management interface of the second functional interface may be displayed.

For another example, assume that the second display interface includes a management interface, a sub-interface A, a sub-interface B, a sub-interface A1, and a sub-interface A2. Where sub-interface A1 and sub-interface A2 are sub-interfaces of sub-interface A. If the interface displayed by the second display interface for the last time before the first switching operation is acquired is the sub-interface A1, then the first display content may correspond to the sub-interface A1. As such, when switching back to the second function interface, the sub-interface A1 may be displayed.

As the user moves away from the second functional interface, the level and/or page content (e.g., page identification) of the currently displayed second functional interface may be recorded. Correspondingly, when the user enters the second functional interface, the first display content may be determined according to the recorded level of the second functional interface. And, after entering the second functional interface, the recorded level of the second functional interface can be made clear so that the level of the second functional interface is recorded when leaving the second functional interface again. Thus, which level the second functional interface is at when the user leaves the second functional interface will be displayed when the user returns to the second functional interface. As such, the level at which the user left the functional interface can be returned without requiring the user to re-enter the corresponding level from the management interface of the second functional interface, simplifying the user operation and improving the user experience.

In some possible implementations, the first display content can include a level of the second functional interface, excluding specific content of the second functional interface. Correspondingly, the operation by the user on the interface different from the second functional interface may make an adjustment to the background data. After the first switching operation is acquired, the specific content displayed by the second functional interface may be determined according to the background data. For example, if a user edits a flowchart using an aPaaS platform, the background data described above may be stored on a background server of the aPaaS platform. The user's operation may modify the background data stored in the background server. After the first switching operation is acquired, the level of the second functional interface may be determined according to the first display content, and the specific content displayed by the second functional interface under the level may be determined according to the background data.

In this way, through synchronization of the background data, different functional interfaces are opened up, so that user operations on one functional interface can be synchronously displayed to other functional interfaces.

Alternatively, in some other possible implementations, the first display content can include specific content displayed on the second functional interface in addition to the level of the second functional interface. Correspondingly, when the user leaves the second functional interface, the specific content displayed by the second functional interface may be recorded. After the first switching operation is acquired, the first display content may be determined according to the specific content displayed by the recorded second functional interface.

For example, in some possible implementations, the specific content displayed by the above-mentioned recorded second functional interface can be taken as the first display content. Thus, when the user returns to the second functional interface, the content displayed on the second functional interface matches the content displayed on the second functional interface when the user leaves the second functional interface, facilitating the user's continued operation, reducing the user's sense of fragmentation.

In practice, the user's operation on the other functional interface may affect the content displayed on the second functional interface. For example, if the second functional interface is a functional interface for editing a flowchart, operations performed in the functional interface for editing code may affect the connection relationships between the flowcharts. Correspondingly, when determining the first display content, it may be adjusted accordingly according to the user-triggered operation, to ensure that the first display content matches the user-triggered operation.

If the content displayed by the second functional interface when the user leaves the second functional interface is referred to as the second display content, the time from when the user leaves the second functional interface to when the user enters the second functional interface becomes the target time period, then the first display content may be determined based on the operation acquired within the target time period on the basis of the second display content.

Specifically, the data adjustment information can be determined according to the acquired operation within the target time period, and then the second display content is adjusted according to the data adjustment information, to acquire the first display content. The data adjustment information refers to the related information of the content adjusted by the operation in the second display content. For example, if a certain operation triggered by the user within the target time period is configured to adjust the information A of the second display content to the information B. The data adjustment information determined according to this operation may then include information B. Correspondingly, when the first display content is determined, the information A in the second display content may be adjusted to the information B according to the data adjustment information.

It needs to be explained that the above-mentioned adjustment to the first display content may be made after the user triggers the first switching operation, and may also be made within the target time period. That is, after leaving the second functional interface, each time the user triggers an operation that may affect the content displayed by the second functional interface, the second display content may be adaptively adjusted. As such, the second display content need not be re-determined after the first switching operation is acquired.

It can be understood that when switching from the first functional interface to the second target interface, the corresponding display content of the first functional interface may also be recorded. In an embodiment of the present disclosure, the display content recorded upon leaving the first functional interface may be referred to as the third display content. Correspondingly, when the first functional interface is entered again, the fourth display content may be determined according to the third display content, thereby displaying the fourth display content in the display interface. The introduction about the third display content can refer to the second display content above, and the introduction about the fourth display content can refer to the third display content above, which are not repeated here.

S103: displaying a first display content on the display interface.

After the first display content is determined, the first display content may be displayed on the display interface. Thus, since the first display content is determined based on historical display content of the second functional interface, the content displayed on the display interface matches the user's historical operations performed on the second functional interface.

In addition, in the second functional interface, the user may also trigger a switching operation to switch the display interface from the second functional interface to another functional interface. For example, if the user triggers the switching operation for switching the display interface to the first functional interface, the fourth display content may be determined according to the third display content described above, and the fourth display content is displayed in the display interface, completing the switching of the display interface.

Embodiments of the present disclosure provide a method of switching display content. If the user wants to switch the display interface from the first functional interface to the second functional interface, the first switching operation may be triggered. After the first switching operation is acquired, the first display content may be determined according to the historical display content of the second functional interface, and displayed on the display interface. Therefore, after switching to the second functional interface, the content seen by the user may not be the original content of the second functional interface, but may be the first display content determined according to the historical display content of the second functional interface. That is, when switching from one functional interface to another functional interface, the content displayed on the switched function interface is not the default display content of the function interface (e.g., the list page interface belonging to the function), but the display content determined according to the historical display situation of the functional interface. As such, the user does not need to re-operate on the second functional interface, the operation path of the user is reduced, and the user experience is improved.

In some application scenarios, embodiments of the present disclosure may be applied to a scenario of generation of an application program of an aPaaS platform. Since the creation process of the application is required to complete page content editing, flow editing, and data object editing, the three types of editing interfaces often require multiple rounds of adjustment, and therefore, it is necessary to switch between the above three types of editing interfaces many times. With the solution of this embodiment, the application developer does not need to first return to another type of application edit list page (e.g., a flow editing page) when going from one type of application edit interface (e.g., a page content editing page) to another type of application edit interface (e.g., a flow editing page), thereby reducing the operating cost of the application developer when jumping between the above three types of editing interfaces when developing an application.

Based on one method of switching display content provided by the above method embodiments, the embodiments of the present disclosure further provide a display content switching apparatus, which will be explained below in conjunction with the accompanying drawings.

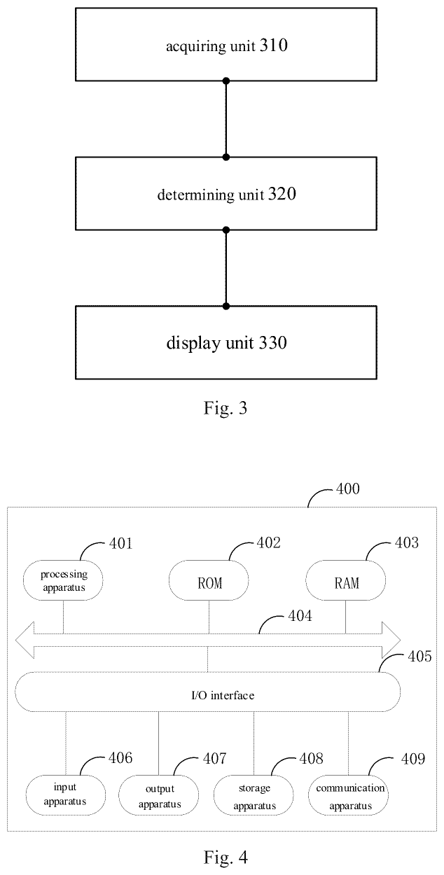

Referring to FIG. 3, which is a schematic structural diagram of a display content switching apparatus provided by an embodiment of the present application. As shown in FIG. 3, the display content switching apparatus 300 includes:

An acquiring unit 310, used for acquiring a first switching operation, wherein the first switching operation is configured to switch a display interface from a first functional interface to a second functional interface, the first functional interface is configured to implement a first editing function, and the second function interface is configured to implement a second editing function. A determining unit 320, used for determining a first display content, wherein the first target display content is determined according to a historically displayed content of the second functional interface. A display unit 330, used for displaying the first display content on the display interface.

In some possible implementations, the first functional interface is configured to edit a first aspect of a target application, and the second functional interface is configured to edit a second aspect of the target application.

In some possible implementations, the first switching operation is triggered by a first switching control, and the first switching control is a control displayed on the first functional interface.

In some possible implementations, an interface indicated by the first display content is determined according to a second functional interface displayed by the display interface at a first moment, the first moment is a moment at which the display interface being switched from the second functional interface to an interface different from the second functional interface, and the first moment is earlier than a moment at which the first switching operation is acquired.

In some possible implementations, a functional interface comprises a management interface and a sub-interface, the management interface is configured to manage an editable flowchart page, and the sub-interfaces is configured to edit the flowchart page. If the display interface at the first moment being the management interface, the display interface is a content displayed by the management interface. If the display interface at the first moment being the sub-interface, the display interface is a content displayed by the sub-interface.

In some possible implementations, the apparatus further comprises a storage unit, the storage unit is configured to store a second display content, the second display content is determined according to the content displayed by the first functional interface when the first switching operation is acquired.

In some possible implementation forms, the obtaining unit 310 is further configured to acquiring a second switching operation, the second switching operation is configured to switch the display interface to the first functional interface. The determining unit 320 is further configured to determine a third display content according to the second display content. The display unit 330 is further configured to display the third display content.

In some possible implementations, the determining unit 320 is specifically configured to determine data adjustment information according to an operation acquired within a target time period, the target time period is a time period from acquiring the first switching operation to acquiring the second switching operation. adjusting the second display content according to the data adjustment information to obtain the third display content.

Based on a method of switching display content provided by the above method embodiment, the present disclosure further provides an electronic device, comprising: one or more processors; and a storage device, on which one or more programs are stored, when the one or more programs are executed by the one or more processors, the one or more processors are caused to implement the method according to any one of the above embodiments.

Reference is now made to FIG. 4, which shows a schematic structural diagram of an electronic device 400 suitable for use in implementing embodiments of the present disclosure. The terminal device in the embodiment of the present disclosure may include, but is not limited to, a mobile terminal such as a mobile phone, a notebook computer, a digital broadcast receiver, a PDA (Personal Digital Assistant), a PAD (tablet computer), a PMP (Portable Media Player), a vehicle-mounted terminal (e.g., a vehicle-mounted navigation terminal), etc., and a fixed terminal such as a digital TV (television), a desktop computer, etc. The electronic device illustrated in FIG. 4 is merely an example and is not intended to suggest any limitation as to the scope of use or functionality of the embodiments of the present disclosure.

As shown in FIG. 4, the electronic device 400 may include a processing apparatus (e.g., a central processor, a graphics processor, etc.) 401, which may execute various appropriate actions and processes according to a program stored in a read-only memory (ROM) 402 or a program loaded into a random-access memory (RAM) 403 from a storage apparatus 408. In the RAM 403, various programs and data required for the operation of the electronic device 400 are also stored. The processing device 401, the ROM 402 and the RAM 403 are connected to each other by a bus 404. An input/output (I/O) interface 405 is also connected to the bus 404.

Generally, the following devices may be connected to the I/O interface 405: input apparatus 408 including, for example, touch screens, touch pads, keyboards, mice, cameras, microphones, accelerometers, gyroscopes, etc.; an output apparatus 407 including, for example, a liquid crystal display (LCD), a speaker, a vibrator, or the like; storage apparatus 408 including, for example, magnetic tape, hard disk, etc.; and a communication apparatus 409. The communication apparatus 409 may allow the electronic device 400 to engage in wireless or wired communication with other devices to exchange data. While FIG. 4 illustrates electronic device 400 with various means, it should be understood that it is not required that all of the illustrated means be implemented or provided. More or fewer devices may alternatively be implemented or provided.

In particular, according to an embodiment of the present disclosure, the processes described above with reference to the flow charts may be implemented as a computer software program. For example, embodiments of the present disclosure include a computer program product comprising a computer program carried on a non-transitory computer readable medium, the computer program containing program code for performing the method illustrated by the flow chart. In such an embodiment, the computer program may be downloaded and installed from the network via the communication apparatus 409, or installed from the storage apparatus 408, or installed from the ROM 402. When this computer program is executed by the processing means 401, the above-described functions defined in the methods of the embodiments of the present disclosure are performed.

The electronic device provided by the embodiment of the present disclosure belongs to the same inventive concept as the method of switching display content provided by the above embodiment, technical details that are not elaborately described in the present embodiment can be referred to the above embodiment, and the present embodiment has the same beneficial effects as the above embodiment.

Based on a method of switching display content provided by the above method embodiments, an embodiment of the present disclosure provides a computer storage medium, on which a computer program is stored, when the program is executed by a processor, the method of switching display content as described in any of the above embodiments is implemented.

It should be noted that the computer-readable medium described above in this disclosure may be a computer-readable signal medium or a computer-readable storage medium or any combination of both. The computer readable storage medium may be, for example, but not limited to, an electronic, magnetic, optical, electromagnetic, infrared, or semiconductor system, apparatus, or device, or any combination of the foregoing. More specific examples of a computer readable storage medium may include, but are not limited to, an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the present disclosure, a computer readable storage medium may be any tangible medium that contains, or stores a program for use by or in connection with an instruction execution system, apparatus, or device. In the present disclosure, a computer readable signal medium may include a propagated data signal with computer readable program code embodied therein, either in baseband or as part of a carrier wave. Such a propagated data signal may take many forms, including, but not limited to, an electromagnetic signal, an optical signal, or any suitable combination of the foregoing. A computer readable signal medium may also be any computer readable medium that is not a computer readable storage medium that can communicate, propagate, or transport a program for use by or in connection with an instruction execution system, apparatus, or device. Program code embodied on a computer readable medium may be transmitted using any appropriate medium, including but not limited to electrical wiring, optical fiber cable, RF (radio frequency), etc., or any suitable combination of the foregoing.

In some implementation, the clients, servers may communicate using any currently known or future developed network protocol, such as HTTP, and may be interconnected with any form or medium of digital data communication (e.g., a communication network). Examples of communication networks include a local area network (“LAN”), a wide area network (“WAN”), an internetwork (e.g., the Internet), and end-to-end networks (e.g., ad hoc end-to-end networks), as well as any currently known or future developed network.

The above-mentioned computer-readable medium may be included in the above-mentioned electronic device; It may also be present separately and not incorporated into the electronic device.

The above-described computer-readable medium carries one or more programs which, when executed by the electronic device, cause the electronic device to perform the above-described method of switching display content.

Computer program code for carrying out operations of the present disclosure may be written in one or more programming languages or combinations thereof, including without limitation an object-oriented programming language such as Java, Smalltalk, C++ and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the scenario involving a remote computer, the remote computer may be connected to the user's computer through any type of network, including a local area network (LAN) or a wide area network (WAN), or the connection may be made to an external computer (for example, through the Internet using an Internet Service Provider).

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or operations or combinations of special purpose hardware and computer instructions.

The units described in the embodiments of the present disclosure may be implemented by means of software or by means of hardware. Therein, the name of the unit/module does not in some cases constitute a limitation of the unit per se, for example, a voice data acquisition module may also be described as a “data acquisition module”.

The functionality described above herein can be performed, at least in part, by one or more hardware logic components. For example, and without limitation, illustrative types of hardware logic components that can be used include Field-programmable Gate Arrays (FPGA), Application-specific Integrated Circuits (ASIC), Application-specific Standard Products (ASSP), System-on-a-chip systems (SOC), Complex Programmable Logic Devices (CPLD), etc.

In the context of the present disclosure, a machine-readable medium may be a tangible medium that can contain, or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of the machine-readable storage medium would include an electrical connection based on one or more wires, a portable computer diskette, a hard disk, a random-access memory (RAM), a read-only memory (ROM), an erasable programmable read-only memory (EPROM or Flash memory), an optical fiber, a convenient compact disc read-only memory (CD-ROM), an optical storage device, a magnetic storage device, or any suitable combination of the foregoing.

It is to be understood that the various embodiments are described in an incremental fashion throughout this specification, and that each embodiment is emphasized as differing from the other embodiments, and that like parts of the various embodiments may be referred to with respect to each other. As for the disclosed system or apparatus of the embodiments, the description is relatively simple because it corresponds to the disclosed method of the embodiments, and is referred to in the methods section where relevant.

It is to be understood that, in this disclosure, “at least one” means one or more and “a plurality” means two or more. “And/or”, used to describe an association relation of an associated object, means that three kinds of relations may exist, for example, “A and/or B” may mean that only A exists, only B exists, and both A and B exist, where A and B may be singular or plural. The character “/” generally indicates that the contextual object is an “OR” relationship. “At least one of the following” or similar expressions, refers to any combination of these items, including any combination of single or plural items. For example, at least one of a, b, or c may mean: a, b, c, “a and b”, “a and c”, “b and c”, or “a and b and c”, wherein a, b, and c may be a single or a plurality.

It is further noted that in this document relational terms such as first and second, and the like, are used solely to distinguish one entity or operation from another entity or operation without necessarily requiring or implying any actual such relationship or order between such entities or operations. Furthermore, the terms “includes,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by the statement “comprises a . . . a” does not, without more constraints, preclude the existence of additional identical elements in the process, method, article, or apparatus that comprises the element.

The previous description of the disclosed embodiments is provided to enable any person skilled in the art to make or use the present disclosure. Various modifications to these embodiments will be readily apparent to those skilled in the art, and the generic principles defined herein may be implemented in other embodiments without departing from the spirit or scope of the disclosure. Thus, the present disclosure is not intended to be limited to the embodiments shown herein but is to be accorded the widest scope consistent with the principles and novel features disclosed herein.

1. A method of switching display content, comprising:
acquiring a first switching operation, wherein the first switching operation is configured to switch a display interface from a first functional interface to a second functional interface, the first functional interface is configured to implement a first editing function, and the second function interface is configured to implement a second editing function;
determining a first display content, wherein the first display content is determined according to a historical display content of the second functional interface; and
displaying the first display content on the display interface.

2. The method according to claim 1, wherein the first functional interface is configured to edit a first aspect of a target application, and the second functional interface is configured to edit a second aspect of the target application.

3. The method according to claim 1, wherein the first switching operation is triggered by a first switching control, and the first switching control is a control displayed on the first functional interface.

4. The method according to claim 1, wherein an interface indicated by the first display content is determined according to the second functional interface displayed on the display interface at a first moment, the first moment is a moment at which the display interface is switched from the second functional interface to an interface different from the second functional interface, and the first moment is earlier than a moment at which the first switching operation is acquired.

5. The method according to claim 4, wherein a functional interface comprises a management interface and a sub-interface, the management interface is configured to manage an editable flowchart page, and the sub-interfaces is configured to edit the flowchart page;
in response to the display interface at the first moment being the management interface, the display interface is a content displayed in the management interface; and
in response to the display interface at the first moment being the sub-interface, is a content displayed in the sub-interface.

6. The method according to claim 1, wherein after acquiring the first switching operation, the method further comprises:
storing a second display content, wherein the second display content is determined according to a content displayed by the first functional interface when the first switching operation is acquired.

7. The method according to claim 6, further comprising:
acquiring a second switching operation, wherein the second switching operation is configured to switch the display interface to the first functional interface;
determining a third display content according to the second display content; and
displaying the third display content.

8. The method according to claim 7, wherein the determining a third display content according to the second display content comprises:
determining data adjustment information according to an operation acquired within a target time period, wherein the target time period is a time period from acquiring the first switching operation to acquiring the second switching operation; and
adjusting the second display content according to the data adjustment information to obtain the third display content.

9. An electronic device, comprising:
one or more processors; and
a storage apparatus, on which one or more programs are stored,
wherein when the one or more programs are executed by the one or more processors, the one or more processors are caused to implement a method of switching display content, which comprises:
acquiring a first switching operation, wherein the first switching operation is configured to switch a display interface from a first functional interface to a second functional interface, the first functional interface is configured to implement a first editing function, and the second function interface is configured to implement a second editing function;
determining a first display content, wherein the first display content is determined according to a historical display content of the second functional interface; and
displaying the first display content on the display interface.

10. The electronic device according to claim 9, wherein the first functional interface is configured to edit a first aspect of a target application, and the second functional interface is configured to edit a second aspect of the target application.

11. The electronic device according to claim 9, wherein the first switching operation is triggered by a first switching control, and the first switching control is a control displayed on the first functional interface.

12. The electronic device according to claim 9, an interface indicated by the first display content is determined according to the second functional interface displayed on the display interface at a first moment, the first moment is a moment at which the display interface is switched from the second functional interface to an interface different from the second functional interface, and the first moment is earlier than a moment at which the first switching operation is acquired.

13. The electronic device according to claim 12, wherein a functional interface comprises a management interface and a sub-interface, the management interface is configured to manage an editable flowchart page, and the sub-interfaces is configured to edit the flowchart page;
in response to the display interface at the first moment being the management interface, the display interface is a content displayed in the management interface; and
in response to the display interface at the first moment being the sub-interface, the display interface is a content displayed in the sub-interface.

14. The electronic device according to claim 9, wherein after acquiring the first switching operation, the method further comprises:
storing a second display content, wherein the second display content is determined according to a content displayed by the first functional interface when the first switching operation is acquired.

15. The electronic device according to claim 14, wherein the method further comprises:
acquiring a second switching operation, wherein the second switching operation is configured to switch the display interface to the first functional interface;
determining a third display content according to the second display content; and
displaying the third display content.

16. The electronic device according to claim 15, wherein the determining a third display content according to the second display content comprises:
determining data adjustment information according to an operation acquired within a target time period, wherein the target time period is a time period from acquiring the first switching operation to acquiring the second switching operation; and
adjusting the second display content according to the data adjustment information to obtain the third display content.

17. A non-transitory computer readable medium, wherein the non-transitory computer readable medium stores computer programs, when the computer programs are executed by a processor, a method of switching display content is implemented, which comprises:
acquiring a first switching operation, wherein the first switching operation is configured to switch a display interface from a first functional interface to a second functional interface, the first functional interface is configured to implement a first editing function, and the second function interface is configured to implement a second editing function;
determining a first display content, wherein the first display content is determined according to a historical display content of the second functional interface; and
displaying the first display content on the display interface.

18. The non-transitory computer readable medium according to claim 17, wherein the first functional interface is configured to edit a first aspect of a target application, and the second functional interface is configured to edit a second aspect of the target application.

19. The non-transitory computer readable medium according to claim 17, wherein the first switching operation is triggered by a first switching control, and the first switching control is a control displayed on the first functional interface.

20. The non-transitory computer readable medium according to claim 17, wherein an interface indicated by the first display content is determined according to the second functional interface displayed on the display interface at a first moment, the first moment is a moment at which the display interface is switched from the second functional interface to an interface different from the second functional interface, and the first moment is earlier than a moment at which the first switching operation is acquired.
